(19) United States
(12) Patent Application Publication
(10) Pub. No.: US 2014/0118916 A1
(43) Pub. Date: May 1, 2014

(54) ELECTRONIC DEVICE

(71) Applicants: INVENTEC (PUDONG) TECHNOLOGY CORPORATION, Shanghai (CN); INVENTEC CORPORATION, Taipei (TW)

(72) Inventor: Chun-Chi Lin, Taipei (TW)

(73) Assignees: INVENTEC CORPORATION, Taipei (TW); INVENTEC (PUDONG) TECHNOLOGY CORPORATION, Shanghai (CN)

(21) Appl. No.: 13/777,840

(22) Filed: Feb. 26, 2013

(30) Foreign Application Priority Data
Oct. 31, 2012 (CN) 201210427601.1

(51) Int. Cl. G06F 1/16

(52) U.S. Cl. CPC G06F 1/166
USPC 361/679.09; 361/679.27

(57) ABSTRACT

An electronic device includes a first body, a second body and a pivotal connecting element. An input module is disposed on the first body. A display monitor is disposed on the second body. The pivotal connecting element includes a first connecting element, a second connecting element and a pivot. The pivot is connected to the first connecting element and the second connecting element. The first connecting element is detachably coupled to the first body. The second connecting element is detachably coupled to the second body, and thereby causes the second body to turn pivotally relative to the first body through the pivotal connecting element.

### CROSS-REFERENCE TO RELATED APPLICATIONS

This non-provisional application claims priority under 35 U.S.C. §119(a) on Patent Application No(s). 201210427601.1 filed in China, P.R.C. on Oct. 31, 2012, the entire contents of which are hereby incorporated by reference.

### BACKGROUND OF THE INVENTION

1. Technical Field of the Invention

The disclosure relates to an electronic device, and more particularly to an electronic device having a pivotal connecting element.

2. Description of the Related Art

With the development of information technology, computer has become an essential tool in everyday life. The development of the computer is from the desktop computer in the early stage toward the laptop. Recently, the tablet computer has become popular among users.

With regard to laptop, it is portable in comparing with desktop computer. Therefore, laptop has become popular among users. However, laptop would be inconvenient for users to carry around if its weight is too heavy. Therefore, to design an electronic device for solving the problem of the inconvenience for users to carry around a heavy laptop has become a task for designers.

### SUMMARY OF THE INVENTION

An electronic device disclosed in one embodiment of the disclosure comprises a first body, a second body and a pivotal connecting element. An input module is disposed on the first body. A display monitor is disposed on the second body. The pivotal connecting element comprises a first connecting element, a second connecting element and a pivot. The pivot is connected to the first connecting element and the second connecting element. The first connecting element is detachably coupled to the first body. The second connecting element is detachably coupled to the second body to cause the second body to turn pivotally relative to the first body through the pivotal connecting element.

### BRIEF DESCRIPTION OF THE DRAWINGS

The disclosure will become more fully understood from the detailed description given herein below for illustration only, and thus does not limit the disclosure, and wherein: FIG. 1A is a perspective view of an electronic device according to one embodiment of the disclosure;

FIG. 1B is a side view of the electronic device in FIG. 1A;

FIG. 2A is another perspective view of the electronic device in FIG. 1A;

FIG. 2B is another perspective view of the electronic device in FIG. 1A;

FIG. 3A is a side view of the electronic device according to another embodiment of the disclosure;

FIG. 3B is a side view of the electronic device according to another embodiment of the disclosure;

FIG. 3C is a side view of the electronic device according to another embodiment of the disclosure;

FIG. 3D is a side view of the electronic device according to another embodiment of the disclosure; and

FIG. 3E is a side view of the electronic device according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The wordings of first, second and third in the descriptions hereafter are used for differentiating different elements, compositions and areas in the drawings. The wordings should not be construed as limitations to the elements, compositions and areas. In other words, without separating from the spirit and scope of the disclosure, a first element, a first composition and a first area described herein can also be a second element, a second composition and a second area.

The directional terms of upper, lower, left and right in the descriptions hereinafter are merely intended for explaining the relative relationships between various elements in the drawings. In other words, without separating from the spirit and scope of the disclosure, the descriptions of an element A being disposed above an element B can also be explained as the element B being disposed above the element A.

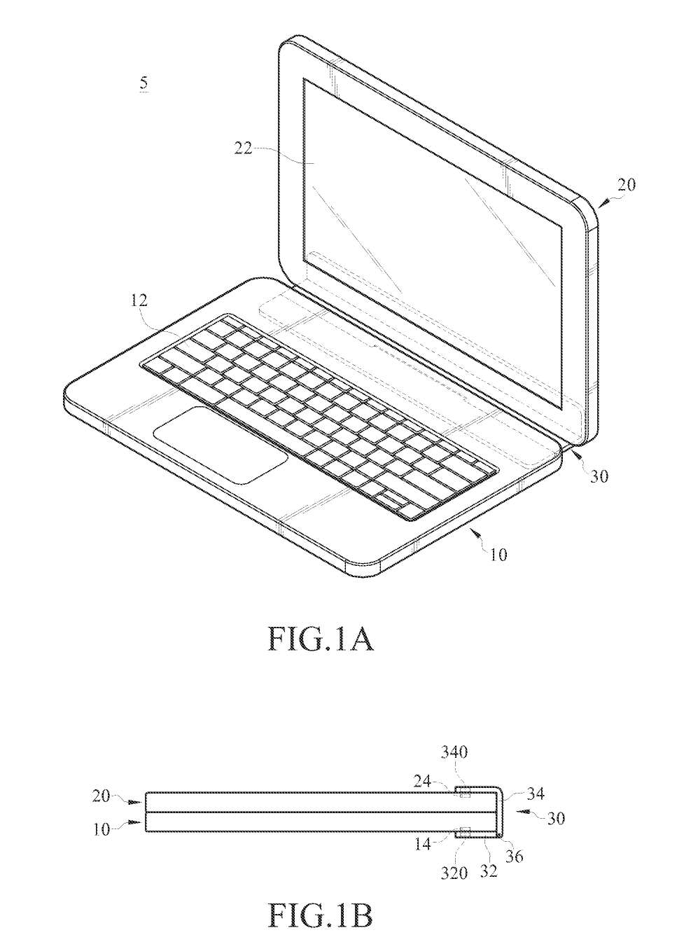

Please refer to FIG. 1A. FIG. 1A is a perspective view of an electronic device according to one embodiment of the disclosure.

An electronic device 5 comprises a first body 10, a second body 20 and a pivotal connecting element 30.

An input module 12 is disposed on the first body 10. In this embodiment, the input module 12 is a keyboard or a touchscreen monitor. A display monitor 22 is disposed on the second body 20. In this embodiment, the display monitor 22 is a touchscreen monitor. The input module 12 and the display monitor 22 are electrically connected to each other wirelessly. In other words, transmitting of signals between the input module 12 and the display monitor 22 is carried out through a first signal transceiver (not shown in the drawings) of the input module 12 and a second signal transceiver (not shown in the drawings) of the display monitor 22. Therefore, commands inputted through the input module 12 by a user can be shown on the display monitor 22.

Detailed descriptions of the pivotal connecting element 30 connecting to the first body 10 and the second body 20 is mentioned hereafter. Please refer to FIG. 1B. FIG. 1B is a side view of the electronic device in FIG. 1A. The pivotal connecting element 30 comprises a first connecting element 32, a second connecting element 34 and a pivot 36. The pivot 36 is connected to the first connecting element 32 and the second connecting element 34. The first connecting element 32 is detachably coupled to the first body 10, and the second connecting element 34 is detachably coupled to the second body 20. Thereby, the first body 10 and the second body 20 may be coupled with the pivotal connecting element 30 for user to use based on requirements. Furthermore, the pivot 36 is connected to the first connecting element 32 and the second connecting element 34. Thus, the user may turn the first body 10 pivotally relative to the second body 20 when the first body 10 and the second body 20 are coupled by the pivotal connecting element 30. In this embodiment, The electronic device 5 further comprises a first magnetic element 320, a second magnetic element 340, a third magnetic element 14 and a fourth magnetic element 24. The first magnetic element 320 is disposed on the first connecting element 32; the second magnetic element 340 is disposed on the second connecting element 34; the third magnetic element 14 is disposed on the first body 10; and the fourth magnetic element 24 is disposed on the second body 20. The first magnetic element 320, the second magnetic element 340, the third magnetic element 14 and the fourth magnetic element 24 are magnets. The first connecting element 32 and the first body 10 are coupled with each other by magnetic inter-attraction between the first magnetic element 320 and the third magnetic element 14. Also, the second connecting element 34 and the second body 20 are coupled with each other by the magnetic inter-attraction between the second magnetic element 340 and the fourth magnetic element 24. However, the coupling way of the first connecting element 32 and the first body 10 as well as that of the second connecting element 34 and the second body 20 should not be construed as a limitation to the disclosure. In other embodiments, the first magnetic element 320 and third magnetic element 14 are a combination of a magnet and a ferromagnetic element respectively. The second magnetic element 340 and the fourth magnetic element 24 are a combination of a magnet and a ferromagnetic element respectively. Thereby, the first body 10, the second body 20 and the pivotal connecting element 30 are coupled with each other.

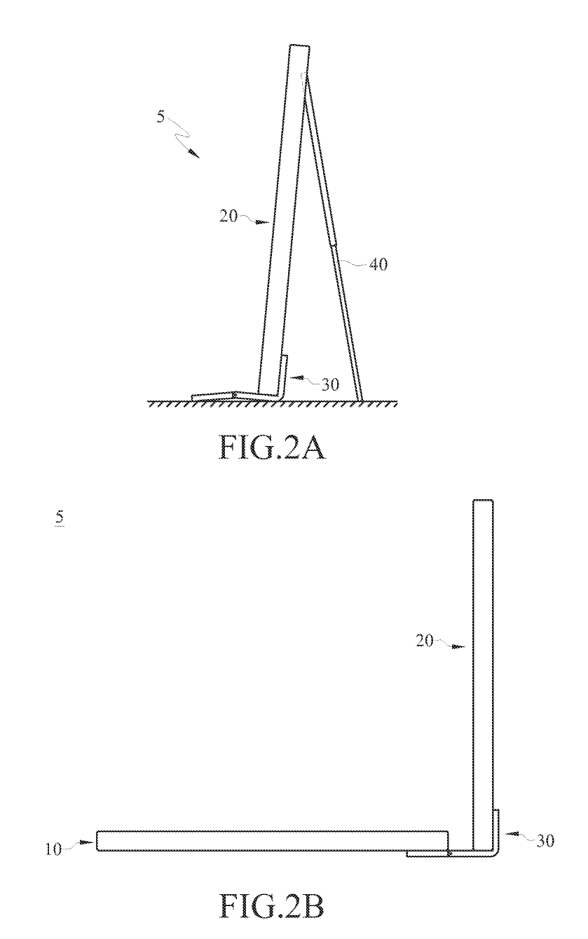

Please refer to FIGS. 2A and 2B. FIG. 2A is another perspective view of the electronic device in FIG. 1A. FIG. 2B is another perspective view of the electronic device in FIG. 1A. In this embodiment, the electronic device 5 further comprises a supporting stand 40 pivotally connected to the second body 20. Thereby, when the user needs to unfold the first body 10 and the second body 20 relative to each other in using the electronic device 5, the user may have the second body 20 being erected on a table by supporting the supporting stand 40 on the table as shown in FIG. 2A. Furthermore, the user may couple the first body 10, the second body 20 and the pivotal connecting element 30 together and use the pivotal connecting element 30 to support the second body 20 to be erected on the table as shown in FIG. 2B.

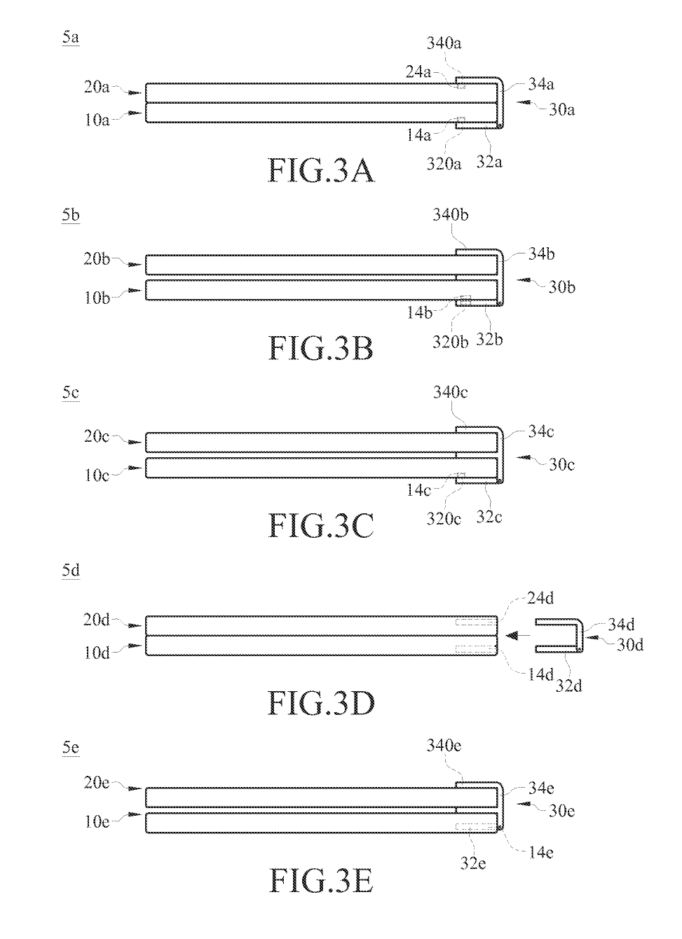

Please refer to FIG. 3A. FIG. 3A is a side view of the electronic device according to another embodiment of the disclosure. This embodiment is similar to the embodiment in FIG. 1A, and the same numbers stand for the same or similar elements of the embodiment in FIG. 1A. Consequently, only differences are illustrated herein. In this embodiment, an electronic device 5a further comprises a first fastening element 320a, a second fastening element 340a, a first fastening portion 14a and a second fastening portion 24a. The first fastening element 320a is disposed on a first connecting element 32a; the second fastening element 340a is disposed on a second connecting element 34a; the first fastening portion 14a is disposed on a first body 10a; and the second fastening portion 24a is disposed on a second body 20a. In this embodiment, the first fastening element 320a and the second fastening element 340a are a protruding post respectively, but not limited thereto. In this embodiment, the first fastening portion 14a and the second fastening portion 24a are a concave groove respectively whose shape corresponds to the protruding post, but not limited thereto. The first connecting element 32a and the first body 10a are coupled with each other by fastening the first fastening element 320a and the first fastening portion 14a with each other. The second connecting element 34a and the second body 20a are coupled with each other by fastening the second fastening element 340a and the second fastening portion 24a with each other. Thereby, the first body 10a, the second body 20a and a pivotal connecting element 30a are coupled with each other.

Please refer to FIG. 3B. FIG. 3B is a side view of the electronic device according to another embodiment of the disclosure. This embodiment is similar to the embodiment in FIG. 1A and the same numbers stand for the same or similar elements of the embodiment in FIG. 1A. Thus, only differences are described herein. In this embodiment, an electronic device 5b further comprises a first magnetic element 320b disposed on a first connecting element 32b and a second magnetic element 14b disposed on a first body 10b. The first magnetic element 320b and the second magnetic element 14b are a magnet respectively. However, this should not be construed as a limitation to the disclosure. In other embodiments, the first magnetic element 320b and the second magnetic element 14b may be a combination of a magnet and a ferromagnetic element. The electronic device 5b further comprises a holding element 340b disposed on a second connecting element 34b. The holding element 340b is a gripping arm protruded from the second connecting element 34b. The holding element 340b matches a second body 20b. The first connecting element 32b and the first body 10b are coupled with each other by the magnetic inter-attraction between the first magnetic element 320b and the second magnetic element 14b. The second connecting element 34b and the second body 20b are coupled with each other by gripping (namely, holding tightly) the second body 20b with the holding element 340b. Thereby, the first body 10b, the second body 20b and a pivotal connecting element 30b are coupled with each other.

Please refer to FIG. 3C. FIG. 3C is a side view of the electronic device according to another embodiment of the disclosure. This embodiment is similar to the embodiment in FIG. 1A, and the same numbers stand for the same or similar elements of the embodiment in FIG. 1A. Thus, only differences are described herein. In this embodiment, an electronic device further 5c comprises a fastening element 320c disposed on a first connecting element 32c and a fastening portion 14c disposed on a first body 10c. The fastening element 320c is a protruding post, and the fastening portion 14c is a concave groove. Nevertheless, they should not be construed as limitations to the disclosure. In other embodiments, the fastening element 320c is a concave groove, and the fastening portion 14c is a protruding post. The electronic device 5c further comprises a holding element 340c disposed on a second connecting element 34c. The holding element 340c is a gripping arm protruded from the second connecting element 34c. The holding element 340c matches a second body 20c. The first connecting element 32c and the first body 10c are coupled with each other by the fastening of the fastening element 320c and the fastening portion 14c. The second connecting element 34c and the second body 20c are coupled with each other by gripping the second body 20c with the holding element 340c. Thereby, the first body 10c, the second body 20c and a pivotal connecting element 30c are coupled with each other.

Please refer to FIG. 3D. FIG. 3D is a side view of the electronic device according to another embodiment of the disclosure. This embodiment is similar to the embodiment in FIG. 1A, and the same numbers stand for the same or similar elements of the embodiment in FIG. 1A. Thus, only differences are described herein. In an electronic device 5d according to of this embodiment, a first body 10d includes a first inserting groove 14d, and a second body 20d includes a second inserting groove 24d. The shape of the first inserting groove 14d matches that of a first connecting element 32d as well as the shape of the second inserting groove 24d matches that of a second connecting element 34d. The first body 10d, the second body 20d and a pivotal connecting element 30d are coupled with each other by inserting the first connecting element 32d into the first inserting groove 14d and inserting the second connecting element 34d into the second inserting groove 24d.

Please refer to FIG. 3E, which is a side view of the electronic device according to another embodiment of the disclosure. This embodiment is similar to the embodiment in FIG. 1A, and the same numbers stand for the same or similar elements of the embodiment in FIG. 1A. Thus, only differences are described herein. In an electronic device 5e according to of this embodiment, a first body 10e includes an inserting groove 14e. The shape of the inserting groove 14e matches that of a first connecting element 32e. The electronic device further 5e comprises a holding element 340e disposed on a second connecting element 34e. The holding element 340e is a gripping arm protruded from the second connecting element 34e. The shape of the holding element 340e matches that of a second body 20e. The first body 10e, the second body 20e and a pivotal connecting element 30e are coupled with each other by inserting the first connecting element 32e into the inserting groove 14e and by gripping (namely, holding tightly) the second body 20e with the holding element 340e.

To sum up, according to the electronic device disclosed in the above-mentioned embodiments of the disclosure, the first body and the second body can be coupled with the pivotal connecting element for using by a user. Or, only the first body is carried around for using. When the user only carries around the first body for using, an overall weight is relatively lighter and is more convenient for carrying around.

What is claimed is:

1. An electronic device, comprising:
a first body, an input module being disposed on the first body;
a second body, a display monitor being disposed on the second body; and
a pivotal connecting element, comprising a first connecting element, a second connecting element and a pivot, the pivot being connected to the first connecting element and the second connecting element, the first connecting element being detachably coupled to the first body, and the second connecting element being detachably coupled to the second body to cause the second body to turn pivotally relative to the first body through the pivotal connecting element.

2. The electronic device as claimed in claim 1, further comprising four magnetic elements being disposed on the first connecting element, the second connecting element, the first body and the second body respectively, and the first connecting element and the first body as well as the second connecting element and the second body being coupled with each other by the magnetic elements.

3. The electronic device as claimed in claim 1, further comprising two fastening elements being disposed on the first connecting element and the second connecting element respectively, the electronic device further comprising two fastening portions being disposed on the first body and the second body respectively, and the first connecting element and the first body as well as the second connecting element and the second body being coupled with each other by the fastening elements and the fastening portions.

4. The electronic device as claimed in claim 1, further comprising two magnetic element being disposed on the first connecting element and the first body respectively, the first connecting element and the first body being coupled with each other by the magnetic elements, the electronic device further comprising a holding element being disposed on the second connecting element, wherein the holding element is adapted to grip the second body such that the second body and the second connecting element are coupled with each other.

5. The electronic device as claimed in claim 1, further comprising a fastening element being disposed on the first connecting element, the electronic device has one fastening portion being disposed on the first body, the first connecting element and the first body being coupled with each other by the fastening element and the fastening portion, the electronic device further comprising a holding element being disposed on the second connecting element, and the holding element is adapted to grip the second body such that the second body and the second connecting element being coupled with each other.

6. The electronic device as claimed in claim 1, wherein each of the first body and the second body has one inserting groove, and the first connecting element and the first body are coupled with each other as well as the second connecting element and the second body are coupled with each other by inserting the first connecting element and the second connecting element into the inserting groove of the first body and the inserting groove of the second body respectively.

7. The electronic device as claimed in claim 1, wherein the first body has an inserting groove, the first connecting element and the first body are coupled with each other by inserting the first connecting element into the inserting groove of the first body, the second connecting element has a holding element, the holding element is adapted to grip the second body such that the second body and the second connecting element are coupled with each other.

8. The electronic device as claimed in claim 1, further comprising a supporting stand pivotally connected to the second body.

9. The electronic device as claimed in claim 1, wherein the input module is a keyboard or a touchscreen monitor.

10. The electronic device as claimed in claim 1, wherein the display monitor is a touchscreen monitor.
